(19) United States
(12) Patent Application Publication
(10) Pub. No.: US 2016/0128156 A1
(43) Pub. Date: May 5, 2016

(54) PROGRAMMABLE GARMENT

(71) Applicant: Jason SEGERS, League City, TX (US)

(72) Inventor: Jason SEGERS, League City, TX (US)

(21) Appl. No.: 14/532,908

(22) Filed: Nov. 4, 2014

(51) Int. Cl. H05B 33/08; A43B 3/00; F21V 33/00

(52) U.S. Cl. CPC H05B 33/0863; F21V 33/0008; A43B 3/001; F21Y 2101/02

(57) ABSTRACT

A programmable garment including a visual stimuli network, a data storage medium including a pattern and color code, and a color pattern control system coupled to the garment and in signal communication with the visual stimuli network, wherein the color pattern control system is configured to display a color pattern on the garment corresponding to the pattern and color code stored on the data storage medium, and the data storage medium is configured to be inserted into the slot of the garment.

### CROSS-REFERENCE TO RELATED APPLICATION

Not Applicable.

### BACKGROUND

1. Field of the Disclosure

The present disclosure relates generally to programmable garments. More particularly, the present disclosure relates to methods and apparatuses for creating color patterns on apparel using a data storage medium and a visual stimuli network.

2. Background of the Technology

Since the introduction of miniaturized, low power lighting technology, various types of apparel have been configured to provide lighting for visual stimuli. For instance, apparel, particularly footwear, has been configured to include one or more lights for providing visual stimuli. Often the source of visual stimuli utilized in these types of apparel is a light emitting diode (LED), which emits light when a voltage is applied across the leads or conductors of the LED. LEDs are often chosen as a source of visual stimuli in this type of application due to the LED's advantages in efficiency and size with respect to incandescent light bulbs. For example, LEDs emit more lumens per watt than incandescent light bulbs and are capable of being manufactured at very small sizes, sometimes on the scale of a few millimeters. Further, LEDs may emit light of any intended color without using any color filters as required with incandescent light sources. Therefore, a multi-color LED, controlled by a digital processor, may emit a sequence of varying colors to enhance the visual stimuli provided by the LED.

However, contemporary apparel configured with sources of visual stimuli, including multi-color LEDs, are limited in the types of visual stimuli they may provide to the wearer and others. For instance, contemporary apparel configured with sources of visual stimuli often only includes one or only a few sources for providing visual stimuli. Thus, the color patterns offered by these apparel light systems are often limited to temporal sequences of varying colors, or a handful of lights for providing a limited color pattern. Also, because only a small number of LEDs or other lights are used for providing visual stimuli, the color pattern provided is limited to a very small portion of the surface of the apparel. These configurations are also limited because often only a single or possibly a handful of color patterns or sequences are programmed into the digital processor controlling the source(s) of visual stimuli. The processor and/or other components configured for storing the color patterns provided by the source(s) of visual stimuli are also typically not separable from the apparel, and thus, new color patterns or sequences may not be introduced to the apparel.

Accordingly, there remains a need in the art for methods and apparatuses directed towards providing a wide range of visual stimuli in the form of color patterns on apparel. Such methods and apparatuses would be particularly well received if they provide color patterns on a substantial portion of the surface of apparel, including footwear, pants, shirts, jackets and the like. Such apparatuses and methods would also be particularly well received if they allowed a user or wearer of the apparel to alternate between different color patterns to offer a wider array of visual stimuli.

### BRIEF SUMMARY OF THE DISCLOSURE

A programmable garment includes a visual stimuli network comprising a plurality of sources of visual stimuli, a data storage medium comprising a pattern and color code, and a color pattern control system coupled to the garment and in signal communication with the visual stimuli network, wherein the color pattern control system is configured to display a color pattern on a display surface of the garment corresponding to the pattern and color code stored on the data storage medium, wherein the data storage medium is configured to be inserted into the slot of the garment, whereby the color pattern control system displays a color pattern on the display surface of the garment corresponding to the pattern and color code stored on the data storage medium. In some embodiments, the plurality of sources of visual stimuli comprise a plurality of light emitting diodes (LEDs). In this embodiment, the plurality of LEDs may comprise a plurality of multi-color LEDs. In certain embodiments, the color pattern control system is configured to display a color pattern on a majority of the display surface of the garment corresponding to the pattern and color code stored on the data storage medium. In certain embodiments, the processor of the color pattern control system is disposed in the data storage medium. In some embodiments, the data storage medium is removeably insertable into the slot of the garment.

A programmable garment includes a visual stimuli network comprising a plurality of sources of visual stimuli, a data storage medium comprising a first pattern and color code, and a color pattern control system coupled to the garment and in signal communication with the visual stimuli network, wherein the first pattern and color code stored on the data storage medium may be replaced by a user with a second pattern and color code. In some embodiments, the plurality of sources of visual stimuli comprise a plurality of light emitting diodes (LEDs). In this embodiment, the plurality of LEDs may comprise a plurality of multi-color LEDs. In certain embodiments, the color pattern control system is configured to display a color pattern on a majority of the display surface of the garment corresponding to the pattern and color code stored on the data storage medium. In certain embodiments, the color pattern control system comprises a processor configured to transmit the pattern and color code data to the visual stimuli network to display a color pattern on the display surface of the garment. In some embodiments, the processor of the color pattern control system is disposed in the data storage medium. In some embodiments, the data storage medium is removeably insertable into the slot of the garment. In certain embodiments, the programmable garment may further include an input device coupled to the data storage medium and configured to allow a user to select between a plurality of color patterns stored on the data storage medium.

A method of displaying a color pattern on a programmable garment includes inserting a first data storage medium into a slot of the garment, transmitting pattern and color code data from the first data storage medium to a visual stimuli network comprising a plurality of sources of visual stimuli, displaying a color pattern on the surface of the garment corresponding to the pattern and color code data. In some embodiments the method may further include removing the first data storage medium from the slot. In some embodiments the method may further include inserting a second data storage medium into the slot. In certain embodiments, displaying a color pattern on the surface of the garment comprises selecting between a plurality of color patterns stored on the first data storage medium using an input device coupled to the first data storage medium. In certain embodiments, displaying a color pattern on the surface of the garment comprises displaying a color pattern on the majority of the surface of the garment.

It is to be understood that both the foregoing general description and the following detailed description are exemplary of the disclosure and are intended to provide an overview or framework for understanding the nature and character of the apparatuses and methods that are disclosed and claimed. The accompanying drawings are included to provide a further understanding of the disclosure and are incorporated in and constitute a part of this specification. The drawings illustrate various exemplary embodiments of the disclosure and together with the written description serve to explain certain principles and operation of the disclosed embodiments.

### BRIEF DESCRIPTION OF THE DRAWINGS

For a detailed description of exemplary embodiments of the invention, reference will now be made to the accompanying drawings in which:

FIG. 1 is a side schematic view of an embodiment of a programmable garment in accordance with principles disclosed herein;

FIG. 2 is a side view of the programmable garment shown in FIG. 1 illustrating varying color patterns in accordance with principles disclosed herein;

FIG. 3A is a side view of another embodiment of a programmable garment illustrating various color patterns in accordance with principles disclosed herein;

FIG. 3B is a side view of another embodiment of a programmable garment illustrating various color patterns in accordance with principles disclosed herein;

FIG. 3C is a side view of another embodiment of a programmable garment illustrating various color patterns in accordance with principles disclosed herein;

FIG. 4 is a flow chart of an embodiment of a programmable garment in accordance with principles disclosed herein;

FIG. 5 is a block diagram of an embodiment of a system for controlling a programmable garment in accordance with principles disclosed herein;

FIG. 6 is a block diagram of another embodiment of a system for controlling a programmable garment in accordance with principles disclosed herein; and

FIG. 7 is a flow chart illustrating a method of displaying one or more color patterns on a programmable garment in accordance with principles disclosed herein.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various exemplary embodiments of the invention. The embodiments disclosed are exemplary only, and thus should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

An embodiment of a programmable garment of the present disclosure is generally configured to provide a visual stimulus via a source of visual stimuli coupled to the programmable garment. More particularly, an embodiment of a programmable garment of the present disclosure is configured to provide visual stimuli in the form of a color pattern disposed on a surface of the garment, where the garment corresponds to an article of clothing or other apparel, such as shoes, pants, shirts, jackets, hats and the like. In an embodiment, a programmable garment provides a color pattern on a substantial portion of the surface of the garment. In this embodiment, the color pattern may comprise a majority of the surface of the programmable garment. Also, in this embodiment the color pattern may be provided by a control system coupled to the programmable garment. As used in this application, the term programmable garment is defined as consisting of garments, apparel, wearable accessories, and cases configured to house portable electronic devices.

In an embodiment, a programmable garment provides a range of visual stimuli by allowing a user to select between different color patterns. In this embodiment, a color pattern may be stored on a data storage medium that is retrievably inserted into a slot extending into the programmable garment. In this embodiment, different color patterns may be selected by replacing a first data storage medium installed in the programmable garment with a second data storage medium, where the second data storage medium includes a different color pattern than the color pattern stored on the first data storage medium. Moreover, in this embodiment a user may configure or design a color pattern and upload the created color pattern to the data storage medium by coupling the data storage medium to a computer, where the color pattern may be displayed on the programmable garment by installing the programmed data storage medium into the slot of the garment.

In an embodiment, a programmable garment is generally configured to produce visual stimuli corresponding to a color pattern disposed on the surface of the garment, where the color pattern is produced by a source of visual stimuli. In this embodiment, the source of visual stimuli may comprise a light emitting diode (LED). Also, in this embodiment the LED may comprise red, green, and blue (RGB) LEDs or multi-colored LEDs configured to mix colors for augmented color rendering capability. In an embodiment, the source of visual stimuli of the programmable garment may be controlled using a control system coupled to the programmable garment. For instance, the control system may include a data storage medium including a processor and a memory that is each powered by a power source coupled to the garment.

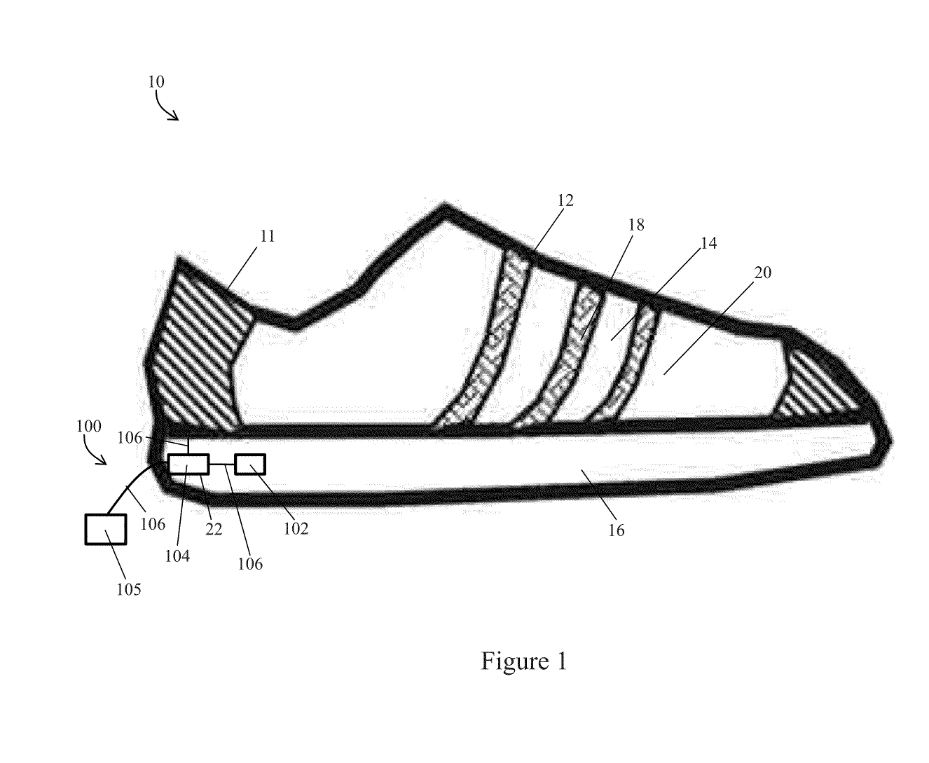

Referring now to FIG. 1, an embodiment of a programmable garment 10 is shown. In this embodiment, the programmable garment 10 comprises a garment 11 having an upper portion 12 having an outer or display surface 14 that is coupled to a sole 16. The upper portion 12 includes a plurality of sources of visual stimuli or a visual stimuli network 18 disposed on the surface 14 of upper portion 12. In this embodiment, the visual stimuli network 18 comprises a plurality or network of LEDs configured to provide or display a plurality of colors and patterns. The sole 16 includes a slot 22 extending therein disposed proximal the heel of the footwear comprising programmable garment 10. While in this embodiment sole 16 is described as including slot 22, in other embodiments slot 22 may be located in other locations of programmable garment 10, including upper portion 12. Further, while in this embodiment slot 22 is shown as being disposed in the heel portion of sole 16, in other embodiments slot 22 may be located at other locations in sole 16 of programmable garment 10.

The visual stimuli network 18 produces a color pattern 20 comprising a plurality of colors disposed on the surface 14 of upper portion 12, where the color pattern 20 provided by visual stimuli network 18 is disposed on a substantial portion of the surface 14 of upper portion 12. In this embodiment, the color pattern 20 provided by network 18 is disposed on the majority of the surface 14 of upper portion 12 of the programmable garment 10. While in this embodiment programmable garment 10 includes a garment 11 corresponding to footwear, in other embodiments garment 11 of programmable garment 10 may include other forms of apparel, such as pants, shirts, jackets, headwear, belts, portable electronic device cases and the like. Also, while in this embodiment the visual stimuli network 18 includes a plurality of LEDs, in other embodiments the visual stimuli network 18 may include a plurality of other types of sources of visual stimuli, such as incandescent light sources and the like. However, while in this embodiment visual stimuli network 18 is described as comprising a plurality of LEDs, in other embodiments visual stimuli network 18 may comprise other sources of visual stimuli configured to provide a plurality of colors through electrically or magnetically induced color changes. For instance, in other embodiments visual stimuli network 18 may comprise plasma, magnetochromatic material, and other sources.

Programmable garment 10 also includes a color pattern control system 100 disposed in sole 16 and generally configured to control the visual stimuli network 18 disposed on surface 14 of upper portion 12. More particularly, the color pattern control system 100 is configured to control the appearance of the color pattern 20 illuminated by the visual stimuli network 18. Thus, the color pattern 20 shown on surface 14 may be altered or otherwise controlled by the input provided by control system 100. Color pattern control system 100 generally includes a power source 102, a data storage medium 104, and a plurality of wires 106. Power source 102 is disposed within soul 16 and is configured to provide power to the data storage medium 104 and visual stimuli network 18, and is coupled to storage medium 104 and network 18 via wires 106. In this embodiment, power source 102 comprises a battery configured to provide an electrical current to data storage medium 104. The battery comprising power source 102 may include various types of batteries known in the art, including rechargeable batteries, that may be replaced (e.g., batteries such as AAA, AA, etc.) or charged via a power or recharging port (not shown) (e.g., lithium-ion batteries, etc.) provided on the surface of the sole 16. In an embodiment, power source 102 may include a manually operated switch (not shown) disposed on the surface of programmable garment 10 for providing power to data storage medium 104 from power source 102. While in this embodiment power source 102 is described as comprising a battery, in other embodiments power source 102 may comprise other types of power sources, including solar, movement based power sources, and others.

Data storage medium 104 is configured to store a color pattern 20 in a memory and communicate the color pattern 20 to the visual stimuli network 18 via wire 106 such that color pattern 20 may be illuminated on the surface 14 of upper portion 12. Thus, data storage medium 104 may include a processor and memory for performing these functions, as will be described in more detail below. Data storage medium 104 is also configured to be insertable into slot 22 of sole 16. Specifically, data storage medium 104 and slot 22 are configured such that storage medium 104 may be removeably inserted into slot 22, whereby (when inserted into slot 22) data storage medium 104 enters into signal communication with power source 102 and visual stimuli network 18 via wires 106. Thus, a user may replace a first data storage medium 104 disposed in slot 22 by removing the first data storage medium 104 from slot 22 and replacing it with a second data storage medium by inserting the second data storage medium into slot 22, whereby a second color pattern corresponding to a second pattern and color code may be displayed on visual stimuli network 18. Alternatively, a first pattern and color code may be replaced on the first data storage medium 104 with a second pattern and color code corresponding to a second color pattern, and a third pattern and color code, and so on. For instance, the first data storage medium could be coupled to an input device 105 via a wire 106 whereby a user could replace the first pattern and color code with a second pattern and color code. In an embodiment, input device 105 may be a computer. Alternatively, the input device 105 may be a key pad, dial, touch screen, or other type of input device 105 allowing a user to directly interface with data storage medium 104 whereby the user may replace a first pattern and color code data with a second pattern and color code data (i.e., the user may select between a plurality of color patterns stored on data storage medium 104). However, input device 105 is an optional component of color pattern control system 100, and is not necessarily included in control system 100. While in this embodiment data storage medium 104 is described as including a memory and a processor for controlling visual stimuli network 18, in other embodiments data storage medium 104 may only include color pattern 20 stored in a memory, and the processor may be disposed in the sole 16 as a separate unit, coupleable to data storage medium 104 via an electronic connection, such as a wire 106. Thus, a processor and power source 102 may be included in sole 16 with only a memory containing the color pattern 20 being insertable into slot 22.

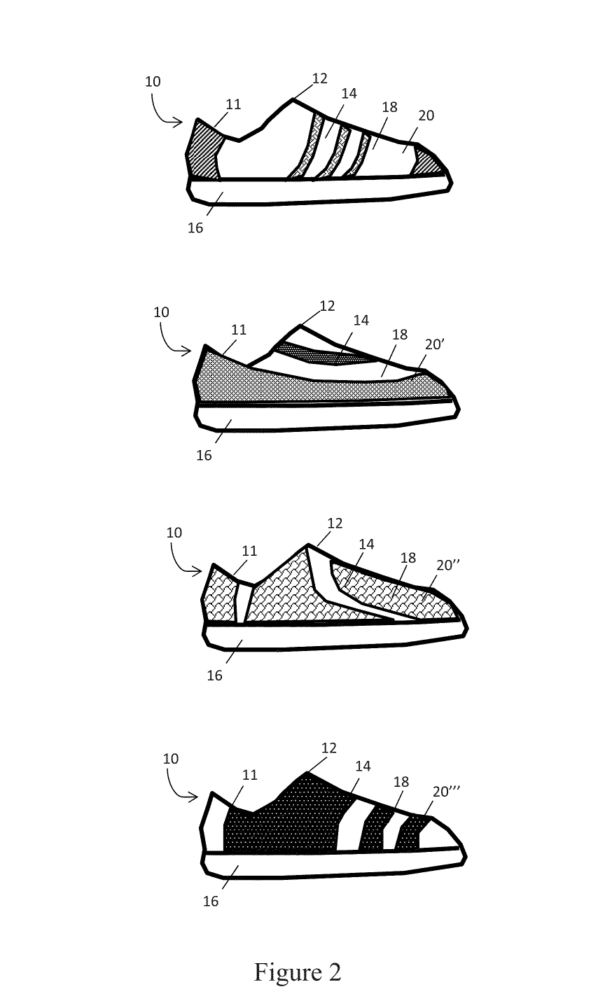

Referring now to FIG. 2, different color patterns 20, 20′, 20″, and 20″′ of programmable garment 10 are shown. Each color pattern 20, 20′, 20″, and 20″′ includes a variety of different colors over a substantial portion of the surface 14 of upper portion 12. Thus, the color pattern control system 100 and visual stimuli network 18 are configured for producing a wide array of visual stimuli, including varieties of colors in different patterns across a substantial portion, a majority, a substantial majority, and/or approximately the entire surface 14 of upper portion 12. The colors included in color patterns 20, 20′, 20″, and 20″′ may include any color in the visible portion electromagnetic spectrum. Further, the color patterns 20, 20′, 20″, and 20″′ may be dynamic, such that color patterns illuminated by visual stimuli network 18 (e.g., patterns 20, 20′, 20″, and 20″′) may change over time in accordance with instructions included on the data storage medium 104. Specifically, color pattern 20 may shift in color and/or pattern over time in a predetermined manner in accordance with instructions provided by storage medium 104.

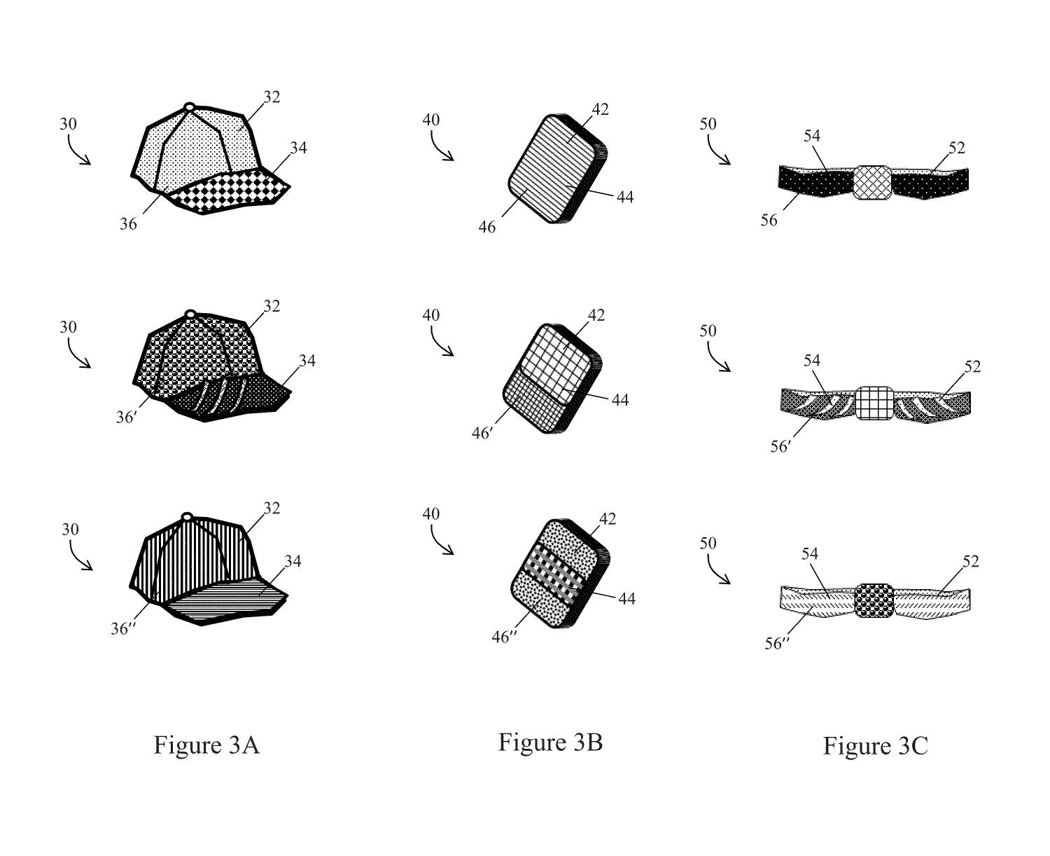

Referring now to FIGS. 3A-3C, other embodiments of programmable garments illustrating various color patterns are shown. FIG. 3A shows a programmable garment 30 corresponding to a hat or cap generally including a display surface 32 having a visual stimuli network 34 disposed thereon that produces a variety of color patterns 36, 36′, and 36″. Similar to programmable garment 10, the display of color patterns 36, 36′, and 36″ on display surface 32 is controlled by a color pattern control system (not shown) including a data storage medium including pattern and color code data. FIG. 3B shows a programmable garment 40 corresponding to a case for a portable electronic device, such as a cell phone. Programmable garment 40 generally including a display surface 42 having a visual stimuli network 44 disposed thereon that produces a variety of color patterns 46, 46′, and 46″. Also similar to programmable garment 10, the display of color patterns 46, 46′, and 46″ on display surface 42 is controlled by a color pattern control system (not shown) including a data storage medium including pattern and color code data. FIG. 3C shows a programmable garment 50 corresponding to a belt generally including a display surface 52 having a visual stimuli network 54 disposed thereon that produces a variety of color patterns 56, 56′, and 56″. Also similar to programmable garment 10, the display of color patterns 56, 56′, and 56″ on display surface 52 is controlled by a color pattern control system (not shown) including a data storage medium including pattern and color code data.

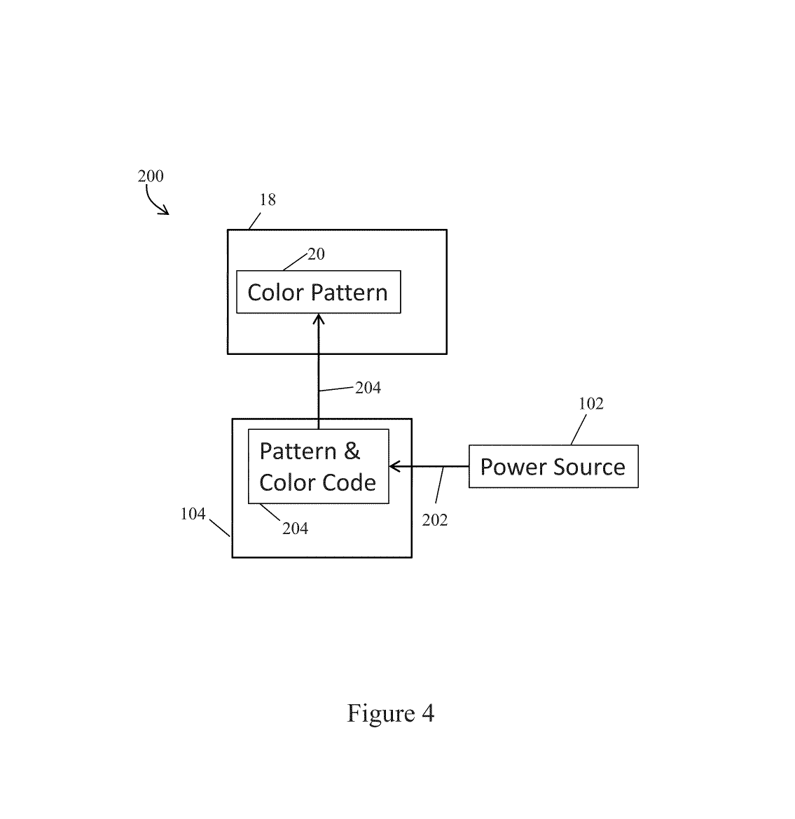

Referring now to FIG. 4, a flow chart 200 of programmable garment 10 is shown. Flowchart 200 illustrates power source 102 providing a source of electrical power 202 flowing to data storage medium 104. Data storage medium 104 is illustrated as including pattern and color code data 204 corresponding to color pattern 20. Pattern and color code data 204 is then transmitted to visual stimuli network 18, which displays it as color pattern 20 on the surface 14 of the upper portion 12 of programmable garment 10. While in the embodiment shown in flowchart 200 includes pattern and color code data 204 corresponding to color pattern 20, in other embodiments pattern and color code data 204 may correspond to other color patterns, such as color patterns 20′, 20″, and 20″′ as well as other color patterns not explicitly disclosed in the present disclosure. The pattern and color code data 204 stored on data storage medium 104 may be altered in some embodiments. For instance, data storage medium 104 may be connected to a computer, allowing the pattern and color code data 204 to be swapped or changed to another pattern and color code corresponding to a different color pattern to be displayed on visual stimuli network 18. Alternatively, pattern and color code data 204 may be hard coded to data storage medium 104, and thus, in order to change color pattern 20 a new data storage medium 104 may need to be inserted into slot 22 of programmable garment 10. While flowchart 200 is described above with respect to programmable garment 10, flowchart 200 is also applicable to programmable garments 30, 40, and 50 shown in FIGS. 3A-3C.

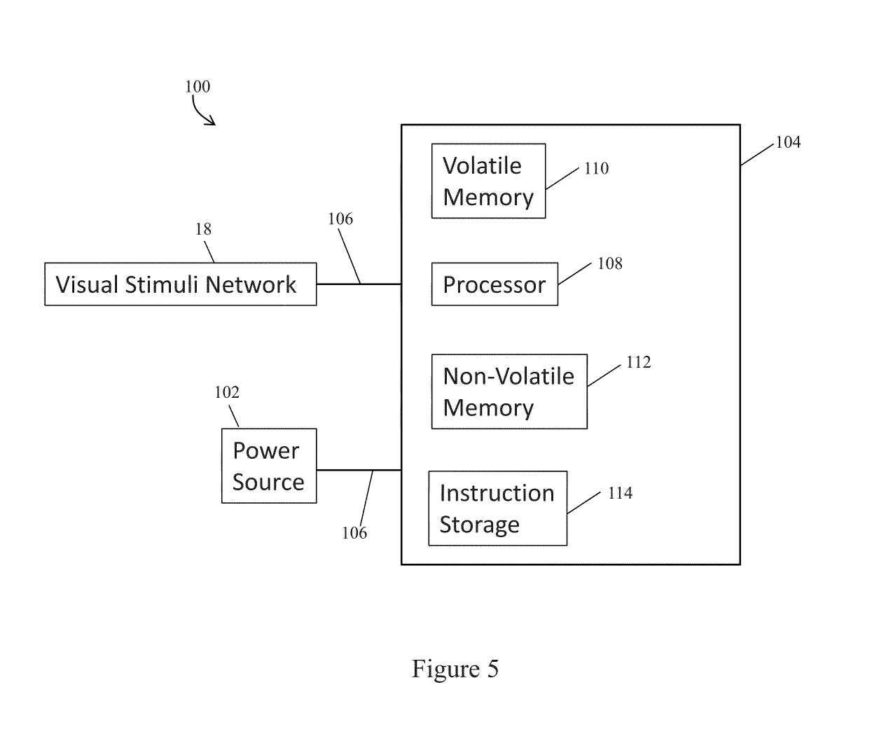

Referring now to FIG. 5, a block diagram of color pattern control system 100 is shown. As described above, control system 100 includes a power source 102 and a data storage medium 104. In the embodiment shown in FIG. 5, color pattern control system 100 further includes a processor 108, volatile memory 110, non-volatile memory 112, and instruction storage 114. The processor 108 may be a general-purpose microprocessor or other instruction execution device suitable for use in a wireless sensor node. The volatile memory 110 retains data stored therein only while powered, and may be a semiconductor random access memory (RAM), such as static RAM (SRAM), or other volatile memory suitable for use with the color pattern control system 100. The non-volatile memory 112 retains data stored therein after power has been removed, and may be a FLASH memory, electrically erasable programmable read-only memory (EEPROM), ferroelectric RAM (FRAM), or other non-volatile memory suitable for use in the color pattern control system 100. The instruction storage 114 may comprise non-volatile and/or volatile memory for storing software instructions that are executed by the processor 108.

In this embodiment, non-volatile memory 112 includes data corresponding to a color pattern (e.g., color pattern 20) to be displayed on visual stimuli network 18. For instance, non-volatile memory 112 may store pattern and color code data 204 to be processed by the processor 108. For instance, processor 108 (via instruction storage 114) may upload the pattern and color code data 204 stored in the non-volatile memory 112 to the volatile memory 110, where data corresponding to a color pattern (e.g., color pattern 20) may then be communicated to the visual stimuli network 18 to be displayed on surface 14 of the upper portion 12.

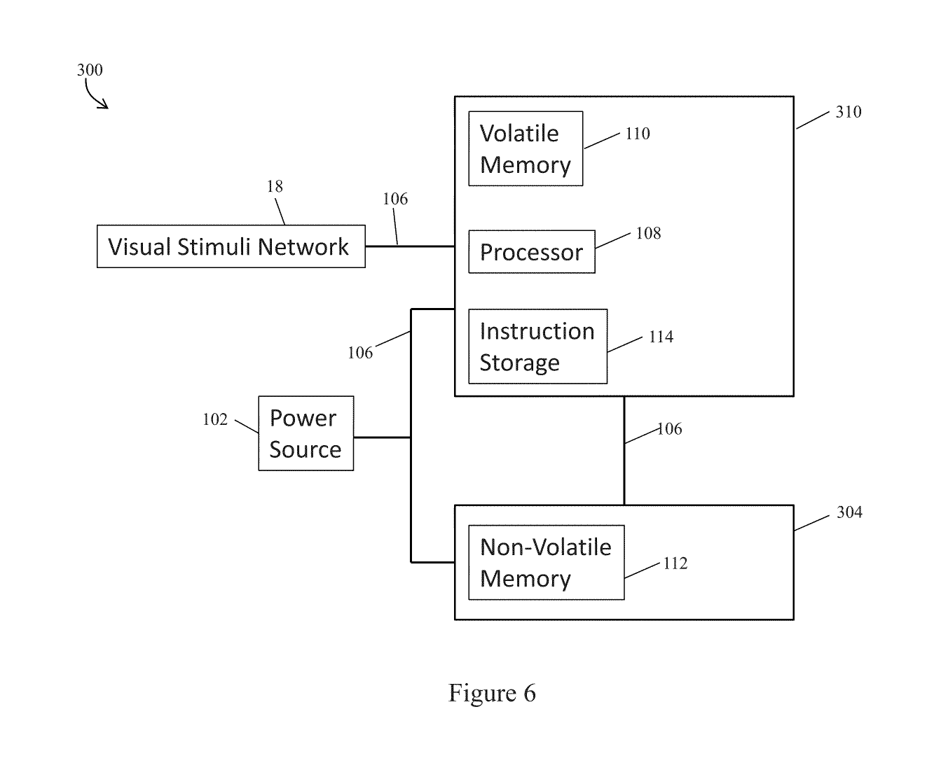

Referring now to FIG. 6, a block diagram of another embodiment of a color pattern control system 300 is shown. In this embodiment, color pattern control system 300 generally includes power source 102, data storage medium 304, and central processing unit (CPU) 310. CPU 310 generally includes processor 108, volatile memory 110, and instruction storage 114. Thus, in this embodiment, processor 108, volatile memory 110, and instruction storage 114 have been included in CPU 310 instead of in data storage medium 304, as with color pattern control system 100. CPU 310 may be permanently stored within sole 16 of programmable garment 10 (or a location disposed on programmable garments 30, 40, and 50 shown in FIGS. 3A-3C) and connectable with data storage medium 304 via a wire 106. Although CPU 310 is stored permanently within sole 16, data storage medium 304 is still insertable into slot 22, similar to storage medium 104. Therefore, multiple color patterns (e.g., color patterns 20, 20′, and 20″, etc.) may be outputted to visual stimuli network 18 by changing the pattern and color code data 204 stored in non-volatile memory 112 of data storage medium 304.

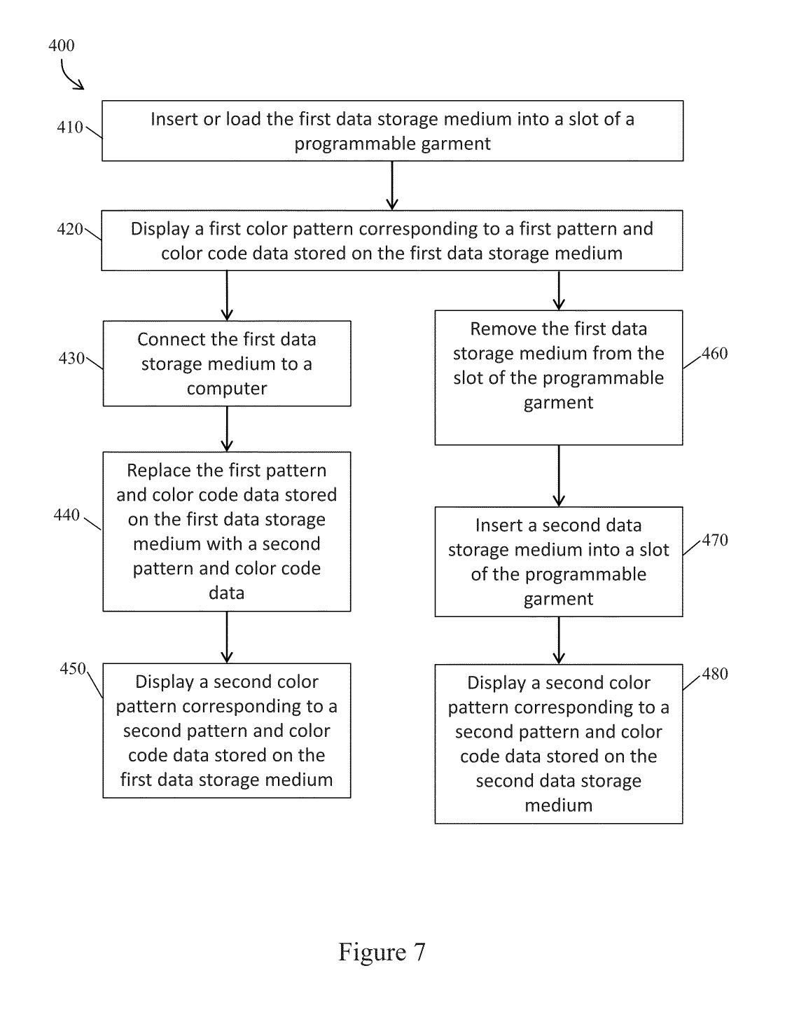

Referring now to FIG. 7, an exemplary method 400 of displaying one or more color patterns on a programmable garment (e.g., garments 10, 30, 40, and 50) is shown. Starting at block 410, a first data storage medium (e.g., data storage medium 104 or 304) is inserted into a slot (e.g., slot 22 of programmable garment 10) of a programmable garment. At block 420 a first color pattern (e.g., one of color patterns 20, 20′, 20″, and 20″′) corresponding to a first pattern and color code (e.g., pattern and color code data 204) stored on the first data storage medium is displayed on the programmable garment. Next, in one embodiment at block 430, the first data storage medium is connected to a computer. At block 440, the first pattern and color code data stored on the first data storage medium is replaced with a second pattern and color code data. Finally, at block 450, a second color pattern (e.g., one of color patterns 20, 20′, 20″, and 20″′) corresponding to a second pattern and color code data stored on the first data storage medium is displayed on the programmable garment. While in this embodiment at block 430 the first data storage medium is connected to a computer, in another embodiment, a user may directly select between a plurality of pattern and color code data selections stored on the first data storage medium using an input device coupled to the first data storage medium, such as a key pad.

Alternatively, in another embodiment, following the display of the first color pattern corresponding to a first pattern and color code data stored on the first data storage medium, at block 460 the first data storage medium is removed from the slot of the programmable garment. Next, at block 470 a second data storage medium is inserted into the slot of the programmable garment. Following this, at block 480 a second color pattern (e.g., one of color patterns 20, 20′, 20″, and 20″′) corresponding to a second pattern and color code data stored on the second data storage medium is displayed on the programmable garment.

The above discussion is meant to be illustrative of principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A programmable garment, comprising:
a visual stimuli network comprising a plurality of sources of visual stimuli;
a data storage medium comprising a pattern and color code; and
a color pattern control system coupled to the garment and in signal communication with the visual stimuli network;
wherein the color pattern control system is configured to display a color pattern on a display surface of the garment corresponding to the pattern and color code stored on the data storage medium;
wherein the data storage medium is configured to be inserted into the slot of the garment, whereby the color pattern control system displays a color pattern on the display surface of the garment corresponding to the pattern and color code stored on the data storage medium.

2. The programmable garment of claim 1, wherein the plurality of sources of visual stimuli comprise a plurality of light emitting diodes (LEDs).

3. The programmable garment of claim 2, wherein the plurality of LEDs comprise a plurality of multi-color LEDs.

4. The programmable garment of claim 1, wherein the color pattern control system is configured to display a color pattern on a majority of the display surface of the garment corresponding to the pattern and color code stored on the data storage medium.

5. The programmable garment of claim 1, wherein the color pattern control system comprises a processor for configuring the visual stimuli network to display the color pattern corresponding to the pattern and color code data.

6. The programmable garment of claim 5, wherein the processor of the color pattern control system is disposed in the data storage medium.

7. The programmable garment of claim 1, wherein the data storage medium is removeably insertable into the slot of the garment.

8. A programmable garment, comprising:
a visual stimuli network comprising a plurality of sources of visual stimuli;
a data storage medium comprising a first pattern and color code; and
a color pattern control system coupled to the garment and in signal communication with the visual stimuli network;
wherein the first pattern and color code stored on the data storage medium may be replaced by a user with a second pattern and color code.

9. The programmable garment of claim 8, wherein the plurality of sources of visual stimuli comprise a plurality of light emitting diodes (LEDs).

10. The programmable garment of claim 9, wherein the plurality of LEDs comprise a plurality of multi-color LEDs.

11. The programmable garment of claim 8, wherein the color pattern control system is configured to display a color pattern on a majority of the display surface of the garment corresponding to the pattern and color code stored on the data storage medium.

12. The programmable garment of claim 8, wherein the color pattern control system comprises a processor configured to transmit the pattern and color code data to the visual stimuli network to display a color pattern on the display surface of the garment.

13. The programmable garment of claim 12, wherein the processor of the color pattern control system is disposed in the data storage medium.

14. The programmable garment of claim 8, wherein the data storage medium is removeably insertable into the slot of the garment.

15. The programmable garment of claim 8, further comprising an input device coupled to the data storage medium and configured to allow a user to select between a plurality of color patterns stored on the data storage medium.

16. A method of displaying a color pattern on a programmable garment, comprising:
inserting a first data storage medium into a slot of the garment;
transmitting pattern and color code data from the first data storage medium to a visual stimuli network comprising a plurality of sources of visual stimuli;
displaying a color pattern on the surface of the garment corresponding to the pattern and color code data.

17. The method of claim 16, further comprising removing the first data storage medium from the slot.

18. The method of claim 16, further comprising inserting a second data storage medium into the slot.

19. The method of claim 16, wherein displaying a color pattern on the surface of the garment comprises selecting between a plurality of color patterns stored on the first data storage medium using an input device coupled to the first data storage medium.

20. The method of claim 16, wherein displaying a color pattern on the surface of the garment comprises displaying a color pattern on the majority of the surface of the garment.
